(19) United States
(12) Patent Application Publication
(10) Pub. No.: US 2020/0206709 A1
(43) Pub. Date: Jul. 2, 2020

(54) HIGH REFRACTIVE INDEX NANOPARTICLES

(71) Applicants: Essilor International, Charenton-le-Pont (FR); SHANGHAI UNIVERSITY, Shanghai (CN)

(72) Inventors: Yves LECLAIRE, Charenton-le-Pont (FR); Jian ZHAO, Charenton-le-Pont (FR); Liyi SHI, Shanghai (CN); Shuai YUAN, Shanghai (CN); Meihong ZHANG, Shanghai (CN); Zhuyi WANG, Shanghai (CN)

(21) Appl. No.: 16/622,438

(22) PCT Filed: Jun. 16, 2017
(86) PCT No.: PCT/CN2017/088805

§ 371 Date: Dec. 13, 2019

(51) Int. Cl. B01J 13/00; C01G 35/00

(52) U.S. Cl. CPC B01J 13/0047; C01P 2002/72; C01P 2004/64; C01G 35/00

(57) ABSTRACT

Disclosed is a synthesis method for preparing tantalum pentoxide colloid including the steps of: a. Providing a transparent solution of amorphous tantalum pentoxide, b. Subjecting the solution to solvothermal conditions in order to form tantalum pentoxide nanocrystals, c. Dispersing the tantalum pentoxide nanocrystals in a solvent so as to form a tantalum pentoxide colloid.

### BACKGROUND OF THE INVENTION

### Field of the Invention

The present invention relates to the field of colloids and colloidal coatings, for use in optical articles.

Tantalum pentoxide, Ta₂O₅, is a high-index, low-absorption material usable for coatings in the near-UV, up to 350 nm, to IR, 8 μm onward, regions. Because of its high dielectric constant, refractive index and thermal stability, this material has more and more applications in the field of capacitors, dynamic random access memories, optical coatings, high-temperature reflectors, and antireflection coatings, among others.

Tantalum pentoxide prepared by physical method usually presents an amorphous structure. As crystalline tantalum pentoxide has more interesting properties, amorphous tantalum pentoxide is usually heated above crystallization temperature, i.e. between 870° K. and 975° K. However, high temperature treatments lead to some agglomeration and are unsuitable in a large variety of applications using plastic substrates such as ophthalmic lenses.

It is thus preferable to use the tantalum pentoxide materials in the form of crystalline nanoparticles, i.e. nanocrystals, dispersed in a liquid. Specifically, there is a need to provide tantalum pentoxide particles dispersed in alcoholic solvents with high solid content. With such concentrated dispersion of particles, one can prepare coating formulations so as to form thin films with high refractive index on various substrates.

### Description of the Related Art

It is known from JP08143315 to perform the synthesis of a tantalum pentoxide solution by precipitation in presence of oxalic acid, at a temperature comprised between 90° and 100° Celsius.

US2009312457 discloses synthesis of tantalum pentoxide nanoparticles stabilized either by a core shell approach or by organosilane grafting.

US2010019201 discloses a continuous hydrothermal process by precipitation with a weak base, tantalum pentoxide is obtained with triethanolamine.

WO2016139013 discloses a process to obtain tantalum pentoxide nanoparticles in water free solvent.

None of these techniques are satisfying as they all fail to provide a way of synthetizing tantalum pentoxide in the form of a stable colloid in water or methanol, in which the size and the dispersity of nanocrystals is sufficiently controlled so as to obtain an overall coating formulation yielding coatings with a high refractive index and good transparency. There is a need for a relatively low-temperature way of synthesizing tantalum pentoxide nanocrystals which can be dispersed in alcohols and remain stable even in case of a high dry content of tantalum pentoxide colloid.

### SUMMARY OF THE INVENTION

The present invention cures the deficiencies of the prior art by providing a synthesis method for preparing tantalum pentoxide colloid comprising the steps of:
a. Providing a transparent solution of amorphous tantalum pentoxide,
b. Subjecting said solution to solvothermal conditions in order to form tantalum pentoxide nanocrystals,
c. Dispersing said tantalum pentoxide nanocrystals in a solvent so as to form a tantalum pentoxide colloid.

In the present description, a solution is understood to be transparent when the observation of an image through said solution is perceived with no significant loss of contrast, that is, when the formation of an image through said solution is obtained without adversely affecting the quality of the image.

The solution of amorphous tantalum pentoxide can be provided by any means. Typically, tantalum precursors are dissolved in a solvent through mechanical agitation, heat and/or acidic oxidative treatment. Said solvent can be water, an organic solvent, such as an alcohol, or a mixture of water and organic solvent (aqueous solvent). It can be a chlorinated solvent. Preferentially, the tantalum pentoxide amorphous solution is obtained by dissolving tantalum pentachloride in a mixture of ethanol and aqueous ammonia.

The transparent solution of amorphous tantalum pentoxide is preferably provided through adding an acidic aqueous solution, preferably an acidic aqueous solution chosen among boric acid, organic acids or their mixtures, to an amorphous tantalum pentoxide aqueous solution.

Alternatively, the transparent solution of amorphous tantalum pentoxide can be provided through adding an acidic aqueous solution of boric acid and an aqueous solution of organic ammonium fluoride to an amorphous tantalum pentoxide aqueous solution. Organic ammonium fluoride (NR₄F) is able to orient particle synthesis to smaller size. It has been experimentally shown that the size of the particles is about 2 nm when organic ammonium fluoride is used, whereas the size of the particles is about 3.5 nm when no organic ammonium fluoride is used.

The resulting slurry can advantageously be filtered and washed until the electroconductivity of the filtrate is below a given threshold, preferably below 100 μs/cm.

During step b, the solution obtained in step a is subjected to solvothermal conditions, preferably to hydrothermal conditions in order to form the tantalum pentoxide nanocrystals. Solvothermal conditions allows for the precise control over the size, shape distribution, and crystallinity of the nanocrystals. These characteristics can be altered by changing certain experimental parameters, including reaction temperature, reaction time, solvent type, surfactant type, and precursor type. The reaction takes place in an autoclave at a pressure above the atmospheric pressure, typically in the range from 0.2 MPa to 2.3 MPa.

Preferentially, step b includes heating the solution by an oven, preferably between 120 and 220° C. Alternatively, step b can include heating the solution through microwaves, preferably between 120° C. and 200° C.

After step b, the synthesis according to the present invention can advantageously comprise a step of neutralization of the obtained solution. Such step can be performed by adding a buffer into the solution in order to bring the pH into neutral range, preferably between 6 and 8. Any buffer solution can be used although a preferred buffer solution is Na₃C₆H₅O₇.2H₂O.

At this stage, a complexing agent can also be added into the solution. Suitable complexing agents include acetylacetone or catechol.

In step c, the tantalum pentoxide nanocrystals are dispersed in a solvent so as to form a tantalum pentoxide colloid. In a preferred embodiment, there is no specific change of solvent at this stage. As such, the solvent into which the tantalum pentoxide nanocrystals are dispersed depends on the previous steps. It can comprise previously mentioned buffer and/or complexing agent, the solvent of the originally used amorphous tantalum pentoxide solution etc.

Step c can advantageously be performed by ultrasonic dispersion.

The synthesis according to the invention can also comprise a solvent exchange step to obtain tantalum pentoxide colloid in a different solvent. Solvent exchange is intended to substitute at least one solvent for part or all of the initial solvent. It may be performed by dialysis or diafiltration (using an ultrafiltration polymer or ceramic membrane). The solvent exchanged step is advantageously performed after step c so as to avoid any aggregation issue during the dispersion. In one embodiment, the solvent exchange step is performed to obtain tantalum pentoxide colloid in a hydroalcoholic mixture, preferably a mixture of water and an alcohol chosen among the C1-C4 alcohols and their mixtures, more preferably methanol.

The tantalum pentoxide colloid can be a colloid dispersed in water. However, in a preferred embodiment, the tantalum pentoxide colloid is a colloid dispersed in an alcohol, preferably an alcohol chosen among the C1-C4 alcohols and their mixtures, preferably methanol.

The synthesis according to the invention can also further comprise a step of concentrating the obtained tantalum pentoxide colloid, preferably by ultrafiltration.

In a preferred embodiment, the obtained concentrated tantalum pentoxide colloid has a dry content of at least 10% by weight, and preferably at least 20% by weight.

The present invention also relates to tantalum pentoxide colloid comprising at least 10% by weight, and preferably at least 20% by weight of orthorhombic tantalum pentoxide nanocrystals in alcohol.

The nanocrystals of the tantalum pentoxide colloid according to the invention can advantageously present a rodlike shape, preferably having a greater dimension from 15 nm to 25 nm and a smaller dimension from 3 nm to 5 nm.

The present invention also relates to an optical article, such as an ophtalmic lens, comprising a transparent polymer substrate and at least one coating prepared from a composition comprising or consisting of a tantalum pentoxide colloid according to the invention.

The transparent polymer substrate has at least one surface coated with said at least one coating.

As used herein, a coating that is said to be coated on a surface of a substrate is defined as a coating, which (i) is positioned above the substrate, (ii) is not necessarily in contact with the substrate, that is to say one or more intermediate layers may be arranged between the substrate and the coating in question, and (iii) does not necessarily completely cover the substrate.

As used herein, the term optical article includes optical lenses such as ophthalmic lenses and semi-finished lenses.

As used herein, a polymer substrate is understood to mean an uncoated polymer substrate, generally with two main surfaces corresponding in the finished ophthalmic lens to the front and rear faces thereof. The bulk of a transparent polymer substrate is made of an optically transparent polymer, generally chosen from transparent polymers of ophthalmic grade used in the ophthalmic industry, and formed to the shape of an optical device. Examples of polymer substrates are those made of thermoplastic or thermosetting resin. Thermoplastic resins may be selected from the group consisting of polyamides, polyimides, polysulfones, polycarbonates (PC), polyethylene terephthalate, poly(methyl(meth)acrylate), cellulose triacetate, and copolymers thereof. Thermosetting resins may be selected from the group consisting of cycloolefin copolymers, homopolymers and copolymers of allyl carbonates of linear or branched aliphatic or aromatic polyols, homopolymers and copolymers of (meth)acrylic acid and esters thereof, homopolymers and copolymers of thio(meth)acrylic acid and esters thereof, homopolymers and copolymers of allyl esters, homopolymers and copolymers of urethane and thiourethane, homopolymers and copolymers of epoxy, homopolymers and copolymers of sulphide, homopolymers and copolymers of disulphide, homopolymers and copolymers of episulfide, and combinations thereof.

Particularly recommended substrates include homopolymers of diethylene glycol bis(allyl carbonate) (CR 39®), allylic and (meth)acrylic copolymers, having a refractive index between 1.54 and 1.58, polymer and copolymer of thiourethane (MR series from Mitsui Chemical), polycarbonates.

A coating formulation is a continuous liquid phase comprising dispersed tantalum pentoxide nanocrystals; optionally an organic binder, for instance an acrylic monomer or an epoxy monomer or a sol-gel system and further optional additives and adjuvants. A suitable coating formulation is stable and transparent to visible light when coated on a lens.

The coating formulation is either dried or cured, by heat or radiation, to yield a coating.

The coating may be deposited through various methods on the substrate, including wet processing (dip coating, spray coating or spin coating) and film transfer.

The optical article of the invention may comprises functional coatings classically used in optics such as an impact-resistant and/or adhesion primer, an abrasion-resistant and/or scratch-resistant coating, an anti-reflection coating, an antistatic coating, an anti-soiling coating, an anti-smudge coating, an anti-dust coating, an anti-fog coating, a water repellent coating, an interferential filter, a tinted coating, a mirror coating, a photochromic coating, and a combination of any of preceding compatible coatings.

### BRIEF DESCRIPTION OF THE DRAWINGS

The present invention will be more fully understood from the following detailed description of the embodiments thereof—to which the invention is not limited however—taken together with the drawings in which:

FIG. 1 is a bloc diagram of an exemplary synthesis according to the invention,

FIG. 2 is an X-Ray Diffraction (XRD) pattern of a tantalum pentoxide colloid obtained through a synthesis according to the present invention,

FIG. 3 is an image obtained by high-resolution transmission electron microscopy (HRTEM) of the sample used to generate the XRD pattern of FIG. 2,

FIG. 4 is an XRD pattern of a tantalum pentoxide colloid obtained through another embodiment of the present invention,

FIG. 5 is an HRTEM image of the sample used to generate the XRD pattern of FIG. 4,

FIG. 6 is an XRD pattern of a tantalum pentoxide colloid obtained through another embodiment of the present invention, and

FIG. 7 is an HRTEM image of the sample used to generate the XRD pattern of FIG. 6.

### DESCRIPTION OF THE PREFERRED EMBODIMENTS

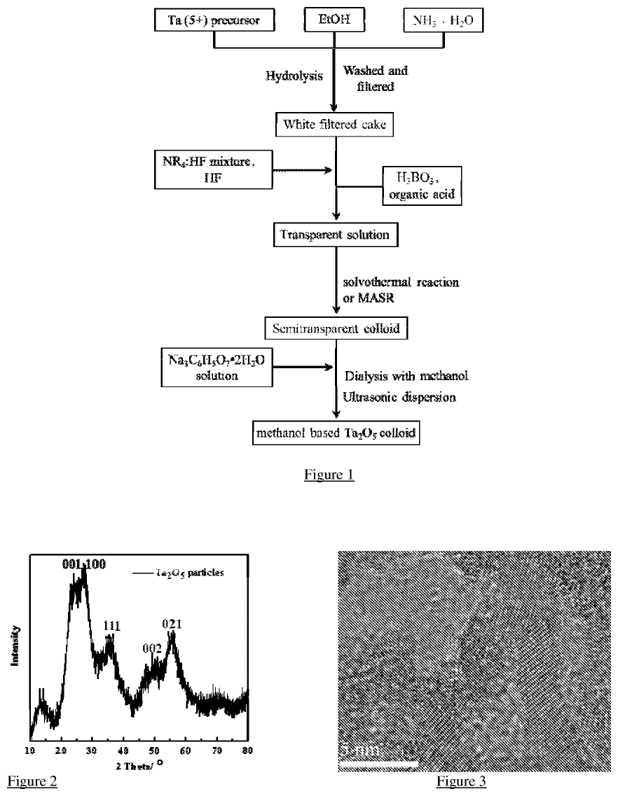

In an exemplary embodiment of the present invention which corresponds to FIG. 1, a tantalum pentoxide colloid is synthetized.

All reagents used were of analytical grade purity. Tantalum pentachloride (TaCl₅), tantalum pentaethanolate (C₁₀H₂₅O₅Ta), tetrabutylammonium fluoride trihydrate (C₁₆H₃₆FN.3H₂O), tetrapropyl Ammonium Fluoride (C₁₂H₂₈FN), tetraethyl ammonium fluoride dihydrate (CsH₂₀FN.2H₂O) and ammonium fluoride (NH₄F) were provided from J&K Scientific Ltd. Ethanol (CH₃CH₂OH), methanol (CH₃OH), ammonium hydroxide (NH₃*H₂O), hydrofluoric acid (HF), orthoboric acid (H₃BO₃), oxalic acid dihydrateacetyl (H₂C₂O₄.2H₂O), citric acid (C₆H₈O₇), tartaric acid (C₄H₆O₆), acetylacetone and catechol and trisodium citrate dihydrate (Na₃C₆H₅O₇.2H₂O) were obtained from Sinopharm Chemical Reagent Co., Ltd.; deionized water was used in the experiment.

First, a tantalum precursor Ta⁵⁺, e.g. in the form of TaCl₅ or tantalum pentaethanolate (C₁₀H₂₅O₅Ta), ethanol and ammonia water are used to prepare amorphous tantalum pentoxide (Ta₂O₅). The pH is preferentially adjusted to a value of 8. The resulting slurry can advantageously be filtered and washed until the electroconductivity of the filtrate is below 100 μs/cm.

Hydrofluoric acid (HF), alone or combined with organic ammonium fluoride, with a combination of water and alcohol as solvent, is then added to the amorphous tantalum pentoxide under mechanical stirring, preferably under strong mechanical stirring, until the amorphous tantalum pentoxide is completely dissolved.

The reactants mole ratio TaCl₅:HF preferably ranges from 0.05:1 to 0.20:1, more preferably is of 0.1:1.

When an organic ammonium fluoride is used, it is preferably chosen among one of tetrabutylammonium fluoride trihydrate (C₁₆H₃₆FN.3H₂O), tetrapropyl Ammonium Fluoride (C₁₂H₂₈FN), tetraethyl ammonium fluoride dihydrate (CsH₂₀FN.2H₂O) or ammonium fluoride (NH₄F). The preferred reactants mole ratio NR₄F:HF is from 0:1 to 2:1.

In order to obtain a transparent solution, an amount of boric acid (H₃BO₃) or of an organic acid, preferably an organic acid chosen among one of oxalic acid dihydrateacetyl (H₂C₂O₄.2H₂O), citric acid (C₆H₈O₇) or tartaric acid (C₄H₆O₆), more preferably oxalic acid dihydrateacetyl, is added to the solution.

In case of boric acid, the preferred reactants mole ratio TaCl₅:H₃BO₃ is from 0.02:1 to 0.1:1, preferably 0.04:1.

In case of organic acid, the preferred reactants mole ratio TaCl₅:organic acid is from 0.25:1 to 5:1, preferably 0.5:1.

The transparent solution is then transferred into a Teflon autoclave to be subjected to solvothermal conditions during a solvothermal time, and heated by oven or microwave (MASR: microwave assisted solvothermal reaction) so as to form tantalum pentoxide nanocrystals. The optimal solvent to perform this solvothermal step is a mixture of water and ethanol with a volumetric ratio of ethanol:water=2:8. The solvothermal temperature preferably ranges between 120-220° C., more preferably 180° C. In case of a regular oven, the solvothermal time preferably ranges from 6 h to 36 h, preferably about 24 h. In case of MASR, the MASR time ranges from 15 minutes to 3 hours, preferably around 1 hour.

After the system has been cooled to room temperature, the obtained tantalum pentoxide nanocrystals are added to a buffer solution, e.g. a Na₃C₆H₅O₇.2H₂O solution, to bring the pH into neutral range, preferably between 6 and 7. The nanocrystals are then dispersed by an ultrasonic cell crasher such as XQ-1000D, Nanjing Xian'ou biological Technology Co., Ltd to form a tantalum pentoxide colloid in water. The obtained colloid is semi-transparent, a state which can also be referred to as translucent which means the colloidal solution diffuses the light of the visible spectrum without stopping it altogether.

A small amount of complexing agent such as acetylacetone or catechol can be added in order to improve the dispersity and stability of the tantalum pentoxide colloid. In that case, the preferred mass ratio of complexing agent acetylacetone or catechol and Ta₂O₅ is from 0:1 to 0.03:1.

Then, the semitransparent colloid is washed with methanol and concentrated by ultrafiltration until the conductivity is stabilized at the lowest point, below 5 s/cm and until the dry content reaches 20% in weight. The ultrafiltration is performed on membrane equipment Sartorius, 10,000 MWCO PES.

In the preparation process, the organic ammonium fluoride could be used to control the size of the tantalum pentoxide nanocrystals.

In order to characterize the tantalum pentoxide colloids, the as-prepared Ta₂O₅ colloid was deposited in a copper-coated carbon grid for investigation by field emission transmission electron microscopy and high-resolution transmission electron microscopy (HRTEM, JEOL JEM-2100F) with the microscope operated at an acceleration voltage of 200 kV. The zeta potential and size distribution of Ta₂O₅ colloid was measured on a Zetasizer 3000HS (Malvern Instrument—Dynamic Light Scattering method). The powder samples were obtained after the sol was dried at 40° C., and then investigated by an X-ray diffraction (XRD) analysis with a Rigaku D/MAX-RB diffractometer using Cu Ku radiation.

The tantalum pentoxide particles grain size has been calculated by Scherrer's formula and is checked to be consistent with the result of HRTEM.

Using amorphous tantalum pentoxide, hydrofluoric acid (HF), tetrabutylammonium fluoride trihydrate (TBAF—C₁₆H₃₆FN.3H₂O), with a mole ratio TBAF:HF equal to 1 and boric acid as reactants, heated by oven at 180° C. for 24 hours, provided tantalum pentoxide nanocrystals with a very good dispersity in water and methanol. Nanocrystals have a zeta potential of −19.0 mV and mean size of 89 nm. The XRD and HRTEM analysis results shown in FIGS. 2 and 3 showed that the tantalum pentoxide particles were orthorhombic crystal with size of about 2 nm.

A 10.0% in weight tantalum pentoxide colloid in methanol remained stable for one week. When the solid content reached a value above 10.0% in weight, the solution became gel because of the small particle size.

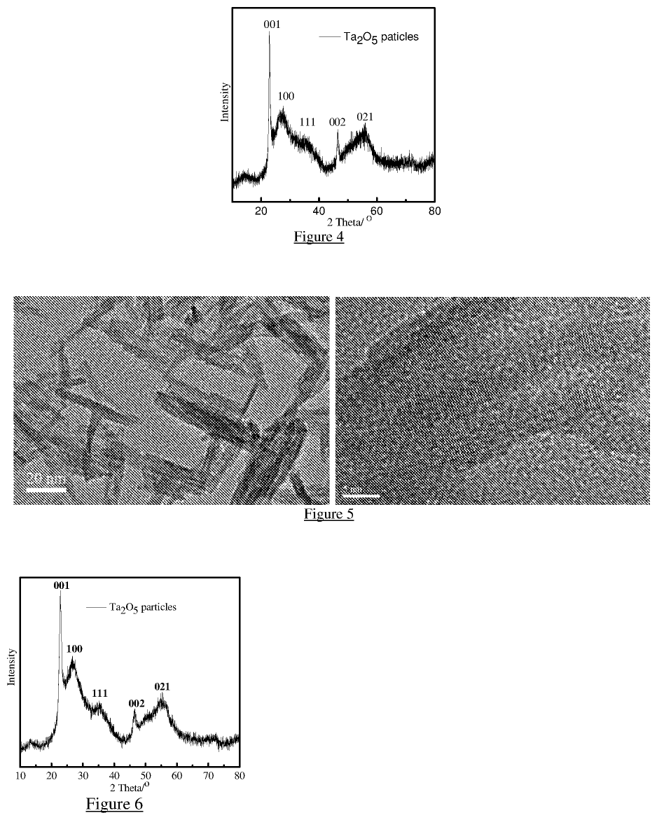

Using the reaction system of amorphous tantalum pentoxide, hydrofluoric acid and oxalic acid dihydrateacetyl, heated by oven at 180° C. for 24 hours, the dispersity and stability of the tantalum pentoxide colloid is improved. The obtained tantalum pentoxide nanocrystals can be well dispersed in water and methanol. Nanocrystals have a zeta potential of −31.7 mV and mean size of 51 nm. The XRD and HRTEM analysis results, which correspond to FIGS. 4 and 5 confirmed that the tantalum pentoxide particles were orthorhombic crystal and had a rodlike shape with a long axis of 30-50 nm and a short axis of 3 to 5 nm. The obtained tantalum pentoxide colloids can be concentrated to 20% solid content in methanol and remain stable for at least one month.

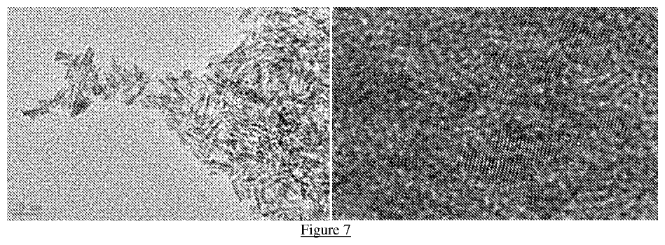

FIGS. 6 and 7 correspond to the result of an experimental protocol in which the heating was performed through microwave instead of a regular oven. Microwave reaction has two effects. On the first hand, it causes a dramatic increase of the reaction rate, and on the other hand, it causes rapid volumetric heating. As such, the microwave-assistant heat leads to explosive nucleation, more nuclei and small size nanocrystals. Microwave-assistant solvothermal reaction (MASR), using amorphous tantalum pentoxide, hydrofluoric acid and oxalic acid dihydrateacetyl as reactant, heated by microwave at 180° C. for 1 hour, lead to tantalum pentoxide nanocrystals which can be well dispersed in water and methanol. Nanocrystals have a zeta potential of −59.5 mV and mean size of 60 nm. The XRD and HRTEM analysis results, which correspond to FIGS. 6 and 7, show that the tantalum pentoxide particles are orthorhombic crystals and have rodlike shape with a long axis of 15-25 nm and a short axis of 3-5 nm. The tantalum pentoxide colloids can be concentrated to 20 wt % solid content in methanol and remain stable for at least one month.

It is understood that the herein described embodiments do not limit the scope of the present invention and that it is possible to implement improvements without leaving the scope of the present invention.

Unless explicitly stated otherwise, the word “or” is equivalent to “and/or”. Similarly, the word “one” or “a” is equivalent to “at least one”, unless stated otherwise.

1. Synthesis method for preparing tantalum pentoxide colloid comprising the steps of:
a. Providing a transparent solution of amorphous tantalum pentoxide,
b. Subjecting said solution to solvothermal conditions in order to form tantalum pentoxide nanocrystals,
c. Dispersing said tantalum pentoxide nanocrystals in a solvent so as to form a tantalum pentoxide colloid.

2. Synthesis method according to claim 1, wherein the transparent solution of amorphous tantalum pentoxide is provided through adding an acidic aqueous solution to an amorphous tantalum pentoxide aqueous solution.

3. Synthesis method according to claim 1, wherein the transparent solution of amorphous tantalum pentoxide is provided through adding an acidic aqueous solution of boric acid and an aqueous solution of organic ammonium fluoride to an amorphous tantalum pentoxide aqueous solution.

4. Synthesis method according to claim 1, wherein step b includes heating the solution by an oven.

5. Synthesis method according to claim 1, wherein step b includes heating the solution through microwaves, preferably between 120 and 200° C.

6. Synthesis method according to claim 1, wherein step c is performed by ultrasonic dispersion.

7. Synthesis method according to claim 1, further comprising a solvent exchange step to obtain tantalum pentoxide colloid in a hydroalcoholic mixture.

8. Synthesis method according to claim 1, wherein the tantalum pentoxide colloid is a colloid dispersed in water.

9. Synthesis method according to claim 1, further comprising a step of concentrating the obtained tantalum pentoxide colloid.

10. Synthesis method according to claim 1, wherein the obtained concentrated tantalum pentoxide colloid has a dry content of at least 10% by weight.

11. Synthesis method according to claim 1, wherein the tantalum pentoxide colloid is a colloid dispersed in an alcohol.

12. Tantalum pentoxide colloid comprising at least 10% by weight of orthorhombic tantalum pentoxide crystals in alcohol.

13. Tantalum pentoxide according to claim 12, wherein the crystals present a rodlike shape.

14. An optical article, comprising a transparent polymer substrate and at least one coating prepared from a composition comprising a Tantalum pentoxide colloid according to claim 12.

15. Synthesis method according to claim 1, wherein the transparent solution of amorphous tantalum pentoxide is provided through adding an acidic aqueous solution to an amorphous tantalum pentoxide aqueous solution, wherein the acidic aqueous solution is selected from the group consisting of boric acid, organic acids and their mixtures.

16. Synthesis method according to claim 1, wherein step b includes heating the solution by an oven to between 120 and 220° C.

17. Synthesis method according to claim 1, wherein step b includes heating the solution through microwaves to between 120 and 200° C.

18. Synthesis method according to claim 1, further comprising a solvent exchange step to obtain tantalum pentoxide colloid in an alcohol.

19. Synthesis method according to claim 1, further comprising a solvent exchange step to obtain tantalum pentoxide colloid in methanol.

20. Synthesis method according to claim 1, further comprising a step of concentrating the obtained tantalum pentoxide colloid by ultrafiltration.
